(19) United States
(12) Patent Application Publication
(10) Pub. No.: US 2019/0234253 A1
(43) Pub. Date: Aug. 1, 2019

(54) ELECTROMAGNETIC ACTUATOR AND METHODS OF OPERATION THEREOF

(71) Applicant: Camcon Auto Limited, Cambridge (GB)

(72) Inventor: Richard Tyrrell, Bury, Pulborough (GB)

(73) Assignee: Camcon Auto Limited, Cambridge (GB)

(21) Appl. No.: 16/332,478

(22) PCT Filed: Oct. 4, 2017
(86) PCT No.: PCT/GB2017/052968

§ 371 Date: Mar. 12, 2019

(30) Foreign Application Priority Data
Oct. 6, 2016 (GB) 1616983.1

(51) Int. Cl. F01L 9/04; F16H 25/14; F16H 53/02

(52) U.S. Cl. CPC F01L 9/04; F16H 25/14; F01L 2009/0432; F01L 2009/0411; F16H 53/025

(57) ABSTRACT

A rotary electromagnetic actuator includes a biasing assembly for applying a torque to its rotor. Such an actuator may be used to operate a poppet valve of an internal combustion engine. The rotor defines a cam surface and the biasing assembly includes a cam follower in engagement with the cam surface, and the magnitude of the torque exerted on the rotor by the biasing assembly is dependent on the magnitude of the displacement of the cam follower by the cam surface. The cam surface defines at least one detent for receiving the cam follower.

### FIELD OF THE INVENTION

The present invention relates to an electromagnetic actuator. More particularly, it relates to a rotary electromagnetic actuator having a rotor which is rotatable relative to a stator and including a biasing assembly for applying a torque to the rotor. Such an actuator may be used to operate a poppet valve of an internal combustion engine for example.

### BACKGROUND TO THE INVENTION

WO2004/097184 describes a rotary electromagnetic actuator which may be used to open and close a valve of an internal combustion engine. In one example, a resilient cantilevered spring arm in contact with the outer circumference of an eccentric surface which rotates with the rotor. The arm is deformed over part of the rotation of the rotor and thereby stores potential energy which is subsequently used to accelerate the rotation of the rotor.

### SUMMARY OF THE INVENTION

The present invention provides an electromagnetic actuator comprising:
a stator;
a rotor which is rotatable relative to the stator over a range of rotation of the rotor; and
a biasing assembly for applying a torque to the rotor over at least part of the range of rotation of the rotor,
wherein the rotor defines a cam surface and the biasing assembly includes a cam follower in engagement with the cam surface, and the magnitude of the torque exerted on the rotor by the biasing assembly is dependent on the magnitude of the displacement of the cam follower by the cam surface, and
wherein the cam surface defines at least one detent for receiving the cam follower.

The presence of a detent in the cam surface may define a rotational position of the rotor relative to the stator through the interaction of the cam surface with the cam follower. The detent may resist rotation of the rotor and its cam surface away from a rotational orientation defined by the detent.

The presence of a detent in the cam surface may facilitate control of the actuator so as more reliably select a rotational position of the rotor defined by the detent during operation of the actuator. The presence of the detent may assist with rotation of the rotor to a specific, predefined rotational position, meaning that a position can be more readily and reliably obtained through the control of the actuator by its control system, in comparison to rotating the rotor to a specific position using electromagnetic forces exerted on the rotor by the stator alone.

In preferred embodiments, the cam follower is displaced between minimum and maximum displacement positions over the range of rotation of the rotor, and the displacement of the cam follower when it is in engagement with the detent is greater than the minimum displacement. Thus, the detent may facilitate reliable selection of a rotational position of the rotor at which the biasing assembly is storing potential energy for use subsequently to exert a torque on the rotor.

In applications where the actuator is used to operate a valve of an internal combustion engine, each cycle of the rotor (which may be a full rotation of the rotor or rotation of the rotor back and forth across its range of rotation) may correspond to a valve event, that is the opening and closing of the associated valve.

In some embodiments, the range of rotation of the rotor may be a portion of a full rotation, with the rotor being controllable to oscillate back and forth over this portion. Alternatively, the range of rotation of the rotor may be a full rotation, enabling the rotor to rotate continuously in the same direction and/or oscillate between two end points.

In preferred embodiments, kinetic energy of the rotor is converted into potential energy stored in the biasing assembly over part of the rotation of the rotor and then this potential energy is subsequently transferred back to the rotor during another part of the rotation of the rotor in order to accelerate the rotation of the rotor.

The cam surface may have a section over which its radius increases from a minimum and then returns back to the minimum (on a radially outwardly facing cam surface, or decreases from a maximum and then returns to the maximum on a radially inwardly facing cam surface). In applications where the actuator is used to operate a valve of an internal combustion engine, such a section may correspond to a cycle of a biasing assembly of energy storage and its subsequent release back to the rotor as the cam follower passes over this section (on a radially outwardly facing cam surface or minimum radius on a radially inwardly facing cam surface). The detent may be provided within such a section. More particularly, it may be provided at or close to the maximum radius of the cam surface in such a section (on a radially outwardly facing cam surface or minimum radius on a radially inwardly facing cam surface). The detent may then be used to define a position at or close to the maximum displacement of the cam follower and therefore at or close to the maximum energy storage in the biasing assembly.

In this way, the detent ensures that a desired cam surface position is selectable in a reliable and stable manner. Preferably, this position is at substantially the maximum displacement of the cam follower. Therefore, substantially the maximum level of energy may be stored in the biasing assembly ready for discharge when required, such as during a subsequent valve event for example. As the detent enables the reliable selection of a specific cam follower displacement, the amount of energy stored will be well-defined and reproducible. Furthermore, it ensures that minimal power if any is consumed by the actuator in order to keep its rotor at the desired rotational position.

The detent may enable such a position to be selected in a stable manner.

The biasing assembly may be implemented mechanically, hydraulically or pneumatically, for example. Preferably, the biasing assembly is a mechanical assembly and comprises a resilient mechanical component. This component may serve to generate a biasing force which is exerted on the rotor by the biasing assembly.

The rotor may be coupled to the biasing assembly such that, as the rotor rotates over at least part of its range of rotation, part of the resilient mechanical component is moved or deflected.

It will be appreciated that the resilient mechanical component of the biasing assembly may take various forms, such as a spring or a block of resilient material.

In some implementations, the resilient mechanical component is a leaf spring. In such a configuration, a portion of the spring which is spaced from the pivot is deflected over at least part of the rotation range of the rotor.

Preferably, the at least one detent comprises portions of the cam surface where its radius of curvature decreases and then increases (on a radially outwardly facing cam surface, or increases and then decreases on a radially inwardly facing cam surface), when moving along the cam surface in a circumferential direction relative to an axis of rotation of the rotor.

A profile of the part of the cam surface which defines the at least one detent may be symmetrical about a line which passes through a point of the profile of minimum radius (on a radially outwardly facing cam surface, or maximum radius on a radially inwardly facing cam surface) and the axis of rotation of the rotor, in a plane which is perpendicular to the axis. In other embodiments, this profile may be asymmetrical about such a line. For example, on one side of this line, the profile may be steeper than the other side. The steeper side may assist with control of a fast rotating rotor to stop at the detent, whilst the shallower side may make it easier to then rotate the rotor back in the opposite direction.

Preferably, part of the resilient mechanical component forms or is coupled to the cam follower and moves in response to movement of the cam follower. The cam follower may comprise a roller, which is urged towards and into contact with the cam surface.

The present invention further provides an internal combustion engine including at least one cylinder having at least one valve and an actuator as described herein, wherein the actuator is arranged to actuate the at least one valve.

Furthermore, the present invention provides a method of operating an electromagnetic actuator comprising:

a stator;
a rotor which is rotatable relative to the stator over a range of rotation of the rotor; and
a biasing assembly for applying a torque to the rotor over at least part of the range of rotation of the rotor,
wherein the rotor defines a cam surface and the biasing assembly includes a cam follower in engagement with the cam surface, and the magnitude of the torque exerted on the rotor by the biasing assembly is dependent on the magnitude of the displacement of the cam follower by the cam surface, and
wherein the cam surface defines at least one detent for receiving the cam follower,
the method comprising the steps of:
passing current through the stator so as to cause rotation of the rotor relative to the stator such that the detent moves towards and into engagement with the cam follower;
then, after a time delay, passing current through the stator so as to cause rotation of the rotor relative to the stator such that the detent moves away from the cam follower.

In some embodiments, the actuator may be operated such that the rotor rotates in the same direction when the detent moves towards and into engagement with the cam follower as when the detent subsequently moves away from the cam follower. Alternatively, in other embodiments, the rotor may be controlled to rotate in the opposite direction as the detent moves away from the cam follower.

### BRIEF DESCRIPTION OF THE DRAWINGS

Embodiments of the invention will now be described by way of example and with reference to the accompanying schematic drawings, wherein:

FIG. 1 is a perspective view of a pair of rotary electromagnetic actuators, with one of the actuators embodying the invention; and

FIG. 2 is a diagram illustrating a cam surface profile and cam follower according to an embodiment of the invention.

### DETAILED DESCRIPTION OF THE DRAWINGS

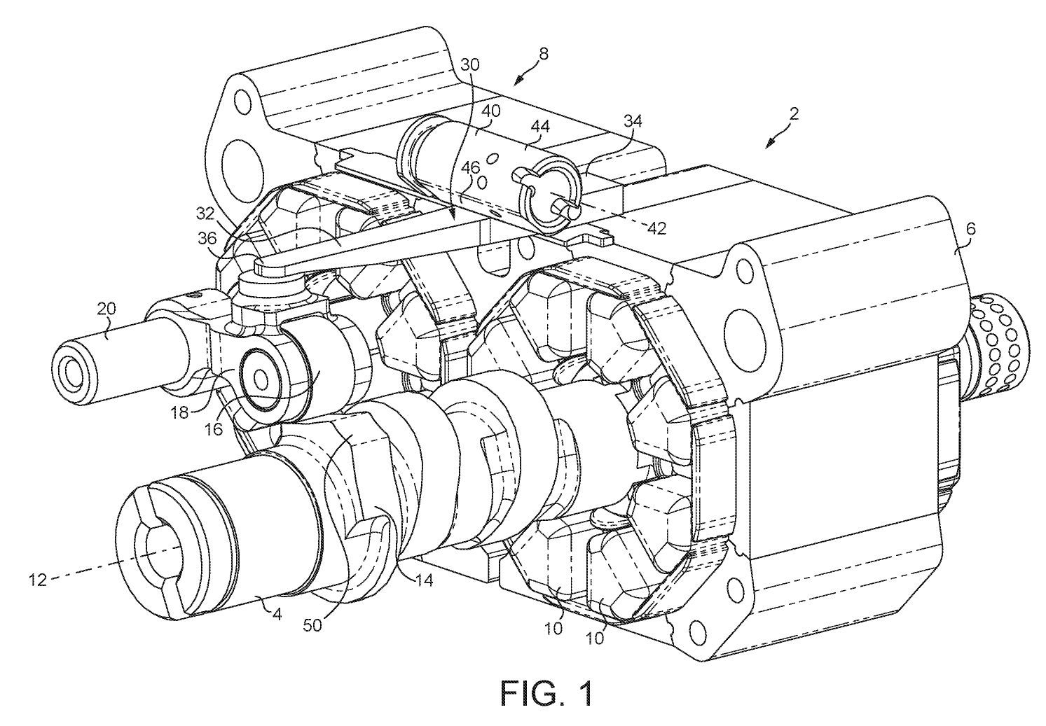

A rotary electromagnetic actuator 2 embodying the invention is shown in FIG. 1. It includes a rotor 4 which is rotatably mounted in a stator 6. In the embodiment shown, the stator 6 is shared with a second actuator 8. The stator includes eight coils 10 which are evenly circumferentially spaced around the rotor, with respect to the rotational axis 12 of the rotor. In operation of the actuator, a magnetically generated torque is exerted on the rotor by selectively energising the stator windings. The rotor of actuator 8 is omitted for clarity in the drawing.

A cam surface 14 is formed on the rotor. A cam follower in the form of a roller 16 is in engagement with the cam surface. The cam follower 16 is rotatably mounted at one end of an arm 18. The other end of the arm is rotatably mounted on a shaft 20. Shaft 20 is supported by a bearing housing for the rotor 4. This bearing housing is omitted for clarity in FIG. 1. The exposed part of the shaft 20 is a press fit into a bore in the bearing housing.

The cam follower 16 is urged into engagement with the cam surface 14 by a biasing assembly 30. This assembly includes a leaf spring 32. The leaf spring is pivotably mounted on the stator 6 at a first end 34. A second, opposite end 36 of the leaf spring bears against the cam follower arm 18, urging it downwardly, towards the cam surface 14. This downward force acts to one side of the rotor axis, rather than towards it, so that it generates a torque around this axis.

The biasing assembly also includes a constraining member in the form of a locking cylinder 40. The locking cylinder 40 is mounted in use for rotation about its central, longitudinal axis 42, by means not shown in FIG. 1. When the locking cylinder is orientated as shown in FIG. 1, its cylindrical circumferential surface 44 is in engagement with the upper surface of the leaf spring 32. The circumferential surface of the locking cylinder also includes a flattened, planar portion 46, which extends in a plane parallel to the rotational axis 42 of the locking cylinder and perpendicular to a plane containing that axis. This aspect is the subject of a co-pending UK patent application filed by the present applicant.

The biasing assembly 30 is rotatable between a configuration (as shown in FIG. 1) in which upwards movement of the leaf spring in response to the interaction between the cam surface 14 and cam follower 16 is constrained by the constraining member 40, and a second configuration in which planar portion 46 is facing the leaf spring. In this second configuration, biasing effect of the assembly is reduced or removed entirely, as the upwards movement of the leaf spring is less constrained or unconstrained by the locking cylinder 40 when its second end 36 is moved in response to the interaction between the cam surface 14 and the cam follower 16. This aspect of the actuator is the subject of a co-pending UK patent application.

The cam surface 14 includes a detent 50. The opposite ends of this section of the cam surface are defined by locations where the profile of the cam surface has a change of curvature. The cam surface profile changes with circumferential position such that, when approaching the detent from either circumferential direction, the radius changes at the edge of the detent from being constant or increasing to decreasing. Continuing along the detent in the same circumferential direction, the radius then increases towards its opposite end. A minimum radius of the detent is therefore defined within the detent. The biasing force on the cam follower towards the cam surface means that when the cam follower is in engagement with the detent, it will tend towards this minimum radius location within the detent.

In the embodiment of FIG. 1, the position defined by the detent is at a location where spring 30 is deflected by the interaction between the cam surface and the cam follower. Thus, potential energy is stored in the form of strain energy within the leaf spring 30 of the biasing assembly at this point. This energy is therefore available for release at a subsequent time.

The provision of the detent reduces the level of precision required in the control system for it to be able reliably to select this position. Once the rotor is orientated such that the cam follower is in contact with the section of the cam surface defining the detent, and providing the angular velocity of the rotor is below a predetermined threshold, the rotor will acquire the rotational position defined by the minimum radius within the detent without requiring more precise control by the control system. This enables the rotor to be reliably “parked” in a predefined rotational position.

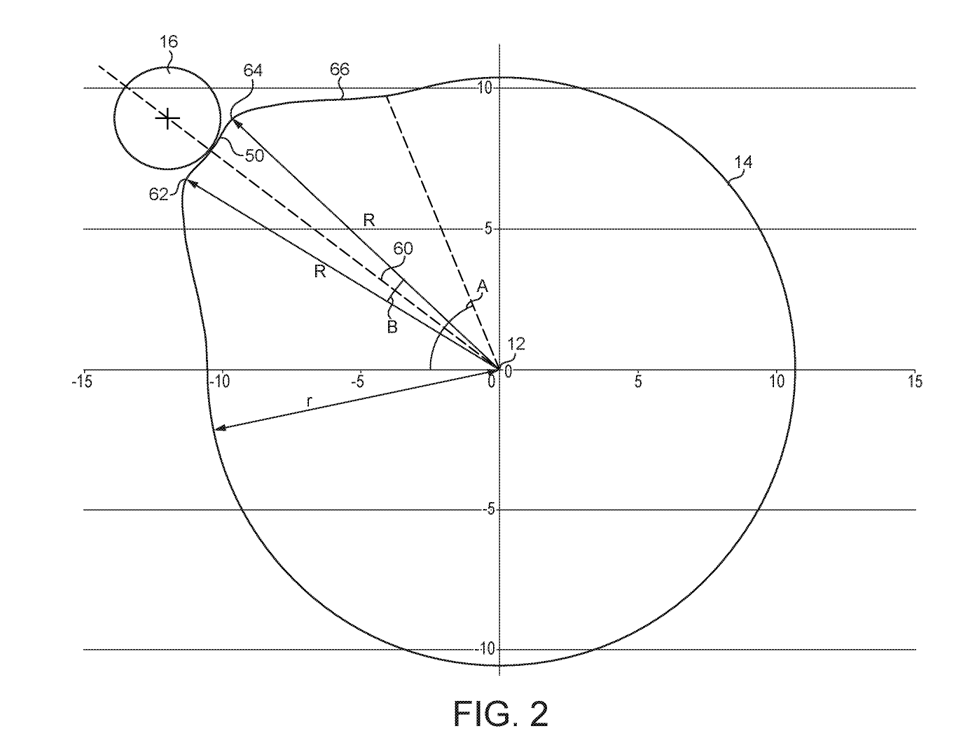

FIG. 2 is a diagram showing a cam surface profile and cam follower in a plane perpendicular to the rotational axis 12 of the rotor.

The cam follower 16 is shown in contact with a detent 50. The detent 50 is symmetrical about a line 60 which extends from the detent to the axis 12 and lies in a plane perpendicular to that axis.

The detent 50 is a section of the cam surface 14 which extends between opposite ends 62 and 64. At each end, the radius of the cam surface changes from increasing to decreasing when moving along the cam surface in the circumferential direction towards the detent.

The cam surface shown in FIG. 2 has a minimum radius “r” and a maximum radius “R”. The maximum radius is reached at each of the ends 62, 64 of the detent 50.

The detent is defined within a portion 66 of the cam surface over which the radius of the cam surface is greater than the minimum value, r. The detent is defined between the points 62 and 64 of maximum radius over portion 66.

Portion 66 subtends an angle “A” of about 72 degrees at the central axis 12 of the rotor. To increase the ability to reliably select the detent, the two edges of the detent (that is the outer edges in the circumferential direction) may subtend a substantial angle B at the axis 12 of the rotor. Preferably, this angle is in a range of around 8° to 15° and more preferably this angle is around 11°.

1. An electromagnetic actuator comprising:
a stator;
a rotor which is rotatable relative to the stator over a range of rotation of the rotor; and
a biasing assembly for applying a torque to the rotor over at least part of the range of rotation of the rotor,
wherein the rotor defines a cam surface and the biasing assembly includes a cam follower in engagement with the cam surface, and the magnitude of the torque exerted on the rotor by the biasing assembly is dependent on the magnitude of the displacement of the cam follower by the cam surface, and
wherein the cam surface defines at least one detent for receiving the cam follower.

2. The actuator of claim 1, wherein the cam follower is displaced between minimum and maximum displacement positions over the range of rotation of the rotor, and the displacement of the cam follower when it is in engagement with the detent is greater than the minimum displacement.

3. The actuator of claim 1, wherein the at least one detent comprises portions of the cam surface where its radius of curvature decreases and then increases, when moving along the cam surface in a circumferential direction relative to an axis of rotation of the rotor.

4. The actuator of claim 1, wherein a profile of a part of the cam surface which defines the at least one detent is symmetrical about a line which passes through a point of a profile of minimum radius and the axis of rotation of the rotor, in a plane which is perpendicular to the axis.

5. The actuator of claim 1, wherein a profile of a part of the cam surface which defines the at least one detent is asymmetrical about a line which passes through a point of a profile of minimum radius and the axis of rotation of the rotor, in a plane which is perpendicular to the axis.

6. The actuator of claim 1, wherein the biasing assembly is a mechanical assembly and comprises a resilient mechanical component.

7. The actuator of claim 6, wherein part of the resilient mechanical component forms or is coupled to the cam follower and moves in response to movement of the cam follower.

8. The actuator of claim 7, wherein the resilient mechanical component is a leaf spring.

9. The actuator of claim 1, wherein the cam follower comprises a roller.

10. An internal combustion engine including at least one cylinder having at least one valve and the actuator of claim 1, wherein the actuator is arranged to actuate the at least one valve.

11. A method of operating an electromagnetic actuator comprising:
a stator;
a rotor which is rotatable relative to the stator over a range of rotation of the rotor; and
a biasing assembly for applying a torque to the rotor over at least part of the range of rotation of the rotor,
wherein the rotor defines a cam surface and the biasing assembly includes a cam follower in engagement with the cam surface, and the magnitude of the torque exerted on the rotor by the biasing assembly is dependent on the magnitude of the displacement of the cam follower by the cam surface, and
wherein the cam surface defines at least one detent for receiving the cam follower,
the method comprising the steps of:
passing current through the stator so as to cause rotation of the rotor relative to the stator such that the detent moves towards and into engagement with the cam follower,
then, after a time delay, passing current through the stator so as to cause rotation of the rotor relative to the stator such that the detent moves away from the cam follower.

12-13. (canceled)
